(19) United States
(12) Patent Application Publication
(10) Pub. No.: US 2013/0113985 A1
(43) Pub. Date: May 9, 2013

(54) IMAGING APPARATUS INCLUDING ZOOM LENS, FOCUS LENS AND FOCUS DRIVER

(71) Applicant: Panasonic Corporation, Osaka (JP)

(72) Inventors: TAKAHIRO IKEDA, Osaka (JP); JUNJI TAKAHATA, Osaka (JP)

(73) Assignee: PANASONIC CORPORATION, Osaka (JP)

(21) Appl. No.: 13/667,015

(22) Filed: Nov. 2, 2012

(30) Foreign Application Priority Data
Nov. 4, 2011 (JP) 2011-242186

(51) Int. Cl. G03B 13/32

(52) U.S. Cl. 348/347; 348/E05.045

(57) ABSTRACT

An imaging apparatus includes a zoom lens, a focus lens, a focus driver for moving the focus lens, a zoom position detector for detecting a position of the zoom lens, a focus position detector for detecting a position of the focus lens, a storing unit for storing the positions of the zoom lens and the focus lens, and a controller. When powering off, the controller stores detected positions of the zoom lens and the focus lens in the storing unit. When powering on, the controller compares a current position of the zoom lens which is detected at the power-on of the imaging apparatus with the stored position of the zoom lens, and controls the focus driver not to move the focus lens to a predetermined initial position of the focus lens.

### BACKGROUND

1. Technical Field

The technical field relates to an imaging apparatus having a zoom lens and a focus lens.

2. Description of Related Art

According to some conventional digital cameras, when such a camera is powered on, the camera sets lens positions, such as a position of a focus lens, for various purposes.

For example, Japanese Patent Laid-Open Publication No. 2009-267482 discloses a video recording apparatus configured to detect whether or not a camera is held by a user's hand when the camera is powered on, and if the camera is held by the user's hand, a position of a zoom lens is set to an initial value; otherwise, the position of the zoom lens is set to a position at which the zoom lens was located when the camera was powered off.

Further, JP07-325244A discloses a camera apparatus configured to move a lens when the apparatus is powered on, based on relative positions of lenses at which the lenses were located when the apparatus was powered off, thus the camera apparatus capable of reducing a time required for moving a focus lens to a position of focus, even if a zoom lens has been moved between when the apparatus was powered off and when the apparatus is powered on.

According to conventional digital cameras capable of the contrast-based autofocus, a reference position of a focus lens is obtained by resetting a position of the focus lens to an initial position (reference position) when a camera is powered on. According to such a digital camera, the focus lens is always set to a predetermined position when the camera is powered on, and the position of the focus lens at which the lenses were located when the apparatus was powered off is not maintained. Accordingly, usability may be reduced in some applications.

### SUMMARY

For example, a user may wish to capture a plurality of images using a digital camera supported by a tripod and with its focus and field angle being fixed. In such a situation, if there is a long time after capturing one image until capturing a next image, it is common from a viewpoint of power saving that the user turns the power of the digital camera off using its power switch (alternatively, the digital camera is operable to be automatically powered off). Then, when the user turns the power on for capturing images, a position of the focus lens is reset. It results in loss of the focus lens' state which had been set just before the camera was powered off, and thus, the user should adjust focus to a desired state again. Therefore, the user should perform extra operations requiring more time, and may miss the best shot, thus reducing usability.

One non-limiting and exemplary embodiment is to provide an imaging apparatus capable of setting, when the imaging apparatus is powered on, a state of the imaging apparatus according to a user's demand including an optical state (a focus state, a zoom state) which had been set when the imaging apparatus was powered off.

According to a first aspect, an imaging apparatus for capturing a subject image to output image data is provided. The apparatus includes a zoom lens configured to move along an optical axis to change magnification of the subject image, a focus lens configured to move along the optical axis to change focus of the subject image, and having a predetermined initial position, a focus driver configured to move the focus lens along the optical axis, a zoom position detector configured to detect a position of the zoom lens, a focus position detector configured to detect a position of the focus lens, a storing unit configured to store the positions of the zoom lens and the focus lens, and a controller configured to control operations of the imaging apparatus. When the imaging apparatus is powered off, the controller stores, in the storing unit, a position of the zoom lens detected at the power-off of the imaging apparatus by the zoom position detector and a position of the focus lens detected at the power-off by the focus position detector. When the imaging apparatus is powered on, the controller compares a current position of the zoom lens detected at the power-on of the imaging apparatus by the zoom position detector with the stored position of the zoom lens, and controls the focus driver not to move the focus lens to an initial position of the focus lens when the current position of the zoom lens is the same as the stored position of the zoom lens.

According to a second aspect, a camera body to which an interchangeable lens including a zoom lens and a focus lens is mountable is provided. The camera body includes a communicating unit configured to receive information on a position of the zoom lens and a position of the focus lens from the interchangeable lens, a storing unit configured to store the received information on the positions of the zoom lens and the focus lens, and a controller configured to control operations of the camera body. When the camera body is powered off, the controller stores, in the storing unit, a position of the zoom lens at the power-off and a position of the focus lens at the power-off. When the camera body is powered on, the controller obtains the information on a position of the zoom lens and a position of the focus lens through the communicating unit, compares the obtained position of the zoom lens with the stored position of the zoom lens, and sends a control signal to the interchangeable lens through the communicating unit for controlling the interchangeable lens not to move the focus lens to an initial position of the focus lens, when the obtained position of the zoom lens is the same as the stored position of the zoom lens.

These general and specific aspects may be implemented using a system, a method, and a computer program, and any combination of systems, methods, and computer programs.

According to the present disclosure, when the imaging apparatus is powered on, the current position of the zoom lens is compared with the previous position of the zoom lens detected when the imaging apparatus was powered off, and if the current position of the zoom lens is the same as the previous position of the zoom lens, the focus lens is not moved to the initial position. If the zoom lens has not been moved, it is judged that a user wishes to capture an image using a past optical state which had been set when the imaging apparatus was powered off. Therefore, according to the present disclosure, when it is supposed that the user wishes to capture an image using a past focus and field angle which had been set when the imaging apparatus was powered off, the position of the focus lens is not reset when the imaging apparatus was powered on. Therefore, it is possible to set, when the imaging apparatus is powered on, a state of the imaging apparatus according to a user's demand including an optical state (a focus state, a zoom state) which had been set when the imaging apparatus was powered off, thus improving usability.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF DRAWINGS

FIG. 1 is a configuration diagram illustrating a digital camera according to an embodiment;

FIG. 2 is a flowchart illustrating an imaging preparation operation (initialization operation) of the digital camera; and

FIG. 3 is a flowchart illustrating an operation for setting a position of a focus lens when the digital camera is powered on.

### DETAILED DESCRIPTION OF PREFERRED EMBODIMENTS

An embodiment will be described in detail below with reference to the drawings.

### Embodiment

A digital camera according to one embodiment will be described below with reference to the drawings.

### 1. Configuration

A configuration of a digital camera will be described below with reference to the drawings.

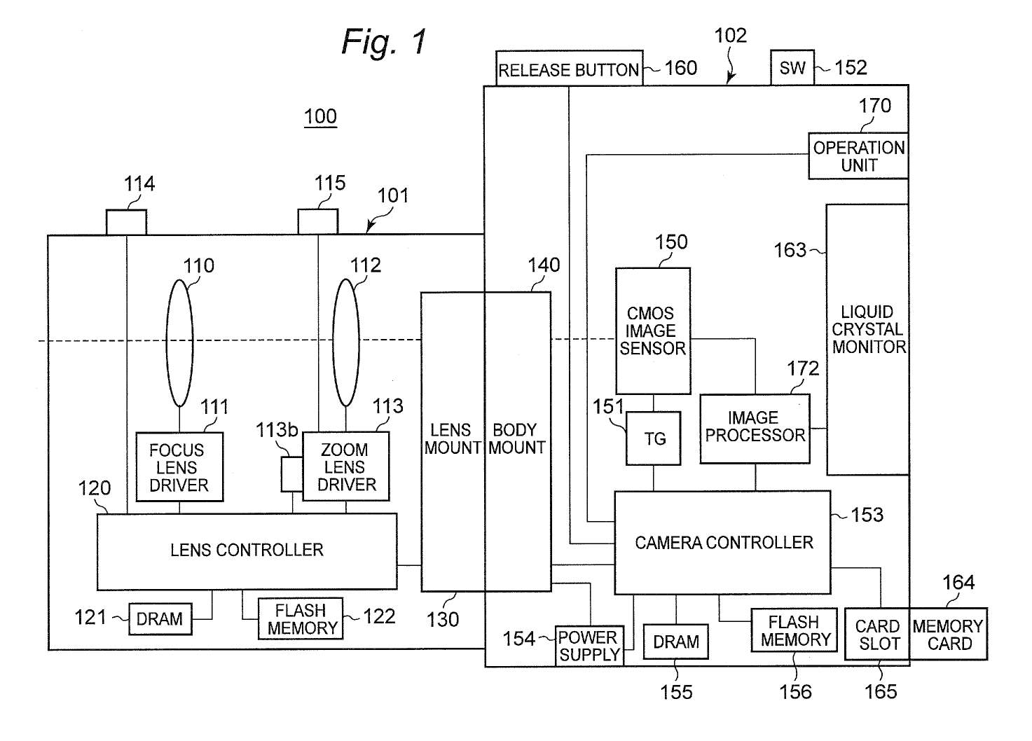

FIG. 1 is a block diagram illustrating a configuration of a digital camera 100 according to this embodiment. The digital camera 100 includes a camera body 102, and an interchangeable lens 101 which can be mounted to the camera body 102. The interchangeable lens 101 has a zoom lens 112 that is driven by a zoom lens driver 113. The camera body 102 can electrically drive the zoom lens 112 through a lens controller 120. That is, the interchangeable lens 101 is an motorized zoom lens.

### 1-1. Configuration of Camera Body

The camera body 102 is provided with a CMOS image sensor 150, a liquid crystal monitor 163, an image processor 172, a timing generator (TG) 151, a camera controller 153, a body mount 140, a release button 160, a console 170, a power supply 154, a DRAM 155, a flash memory 156, and a card slot 165.

The camera controller 153 controls entire operations of the digital camera 100 by controlling respective units such as the CMOS image sensor 150 according to commands from user-control members such as the release button 160 and the console 170. The camera controller 153 sends a vertical synchronizing signal to the timing generator 151. Simultaneously, the camera controller 153 generates an exposure synchronizing signal based on the vertical synchronizing signal. The camera controller 153 periodically and repeatedly sends the generated exposure synchronizing signal through the body mount 140 and a lens mount 130 to the lens controller 120. Accordingly, the camera controller 153 can control lenses such as a focus lens 110 of the interchangeable lens 101 so as to synchronize with each moment of exposure. The camera controller 153 uses the DRAM 155 as a work memory during a control operation and an image processing operation. The camera controller 153 may be configured as a hard-wired electronic circuit or as a microcomputer using a program. Further, the camera controller 153 may be configured as the same semiconductor chip with the image processor 172 and the DRAM 155, or as a different semiconductor chip from them.

The CMOS image sensor 150 is provided with a light-receiving element, an AGC (gain control amplifier), and an AD converter. The light-receiving element converts an optical signal collected by the interchangeable lens 101 into an electric signal, and generates image information. Then, the AGC amplifies the electric signal outputted from the light-receiving element. The AD converter converts the electric signal outputted from AGC into a digital signal. The CMOS image sensor 150 operates according to a timing signal generated by the timing generator 151. Operations of the CMOS image sensor 150 according to the timing signal include: capturing a still image, capturing through-the lens images, transferring data, releasing an electronic shutter, etc. The through-the lens images are mainly video images, and are displayed on the liquid crystal monitor 163 in order to determine a composition of a still image to be captured. The image information generated by the CMOS image sensor 150 is passed to the image processor 172. Alternatively, other imaging devices such an NMOS image sensor or a CCD image sensor may be used instead of the CMOS image sensor 150.

The image processor 172 applies predetermined image processes to image data which has been converted into the digital signal by an AD converter of the CMOS image sensor 150. The predetermined image processes may includes: gamma correction, white balance correction, damage correction, YC conversion, digital zooming, compression, and decompression, but not limited thereto.

The liquid crystal monitor 163 is a display unit disposed on a backside of the camera body 102. The liquid crystal monitor 163 displays an image represented by image information for display processed by the image processor 172. The liquid crystal monitor 163 can selectively display either of a video image and a still image. In addition to images, the liquid crystal monitor 163 can display information on settings of the digital camera 100, etc. In this embodiment, the liquid crystal monitor 163 is shown as one example of the display unit, but the display unit is not limited thereto. For example, an organic electro-luminescence display may be used as the display unit.

The flash memory 156 serves as an internal memory for storing image information, etc. Further, the flash memory 156 stores programs and parameters used in the control of the camera controller 153.

The card slot 165 is an interface for the camera body 102 to receive a memory card 164. The memory card 164 can be electrically and mechanically connected to the card slot 165. The card slot 165 may be operable to control the memory card 164.

The memory card 164 is an external memory that contains a storage device such as the flash memory. The memory card 164 can store data such as the image information processed by the camera controller 153. Further, the memory card 164 can output the data such as the image information stored therein. The image data read from the memory card 164 is processed by the camera controller 153 and the image processor 172, and displayed on, for example, the liquid crystal monitor 163. In this embodiment, the memory card 164 is shown as one example of the external memory, but the external memory is not limited thereto. A recording medium such as an optical disc can be used as the external memory.

The body mount 140 can be mechanically and electrically connected to the lens mount 130 (described later) of the interchangeable lens 101. The body mount 140 enables data to be transmitted and received between the camera body 102 and the interchangeable lens 101 through the lens mount 130. The body mount 140 sends the exposure synchronizing signal and other control signals received from the camera controller 153, to the lens controller 120 through the lens mount 130. Further, the body mount 140 sends signals received from the lens controller 120 through the lens mount 130, to the camera controller 153.

The power supply 154 supplies power for driving the digital camera 100. The power supply 154 may be, for example, a dry battery or a rechargeable battery. Alternatively, the digital camera 100 may be externally powered through a power supply cord. The digital camera 100 is powered on and off using a power switch 152. When the digital camera 100 is powered on, the camera controller 153 supplies power to respective units of the camera body 102. Further, the camera controller 153 also supplies power to the interchangeable lens 101 through the body mount 140 and the lens mount 130. In the interchangeable lens 101, the lens controller 120 (described later) supplies power to respective units of the interchangeable lens 101.

The release button 160 detects the user's instructions for focusing automatically or for capturing an image. The release button 160 can be operated at two states, including a half-press state and a full-press state. When the user half presses the release button 160 (i.e. half-press state), the camera controller 153 focuses automatically. Further, when the user fully presses the release button 160 (i.e., full press state), the camera controller 153 records image data generated when the release button is fully pressed, into the memory card 164.

The console 170 includes a cross button (i.e., up, down, right, and left buttons) for detecting instructions each corresponding to the user's operation in one of up, down, right, and left directions. When the interchangeable lens 101 having the motorized zoom function is mounted to the camera body 102, the camera controller 153 assigns functions as zoom buttons to the right button and the left button of the console 170, respectively. For example, the camera controller 153 assigns the function as a zoom-out (wide-angle) button to the left button, and assigns the function as a zoom-in button (telephoto) to the right button. When the interchangeable lens 101 having the motorized zoom function and mounted to the camera body 102 has a zoom lever for the user to control the zoom operation, the console 170 is not necessarily assigned with the function as the zoom buttons.

### 1-2. Configuration of Interchangeable Lens

The interchangeable lens 101 is provided with the focus lens 110, a focus lens driver 111, a focus ring 114, the zoom lens 112, the zoom lens driver 113, a zoom ring 115, the lens controller 120, a DRAM 121, the flash memory 122, and the lens mount 130. The interchangeable lens 101 may be further provided with a camera shake correction lens as well as the lenses shown in FIG. 1.

The lens controller 120 controls entire operations of the interchangeable lens 101. The lens controller 120 may be configured as a hard-wired electronic circuit or as a microcomputer using a program.

The lens controller 120 uses the DRAM 121 as a work memory during a control operation. The flash memory 122 stores programs, parameters, and lens data to be used for the control operation of the lens controller 120. The lens data includes characteristic values specific to the interchangeable lens 101, such as a lens name, a lens ID, a serial number, a F number, and a focal distance. As described later, the lens controller 120 notifies the camera controller 153 of the lens data, and the camera controller 153 can perform various control operations according to the lens data.

The zoom lens 112 is a lens for changing magnification of a subject image formed by an optical system of the interchangeable lens 101. The zoom lens 112 may be configured to include any number of the lenses or lens groups.

The zoom lens driver 113 includes a mechanics for moving the zoom lens 112 along an optical axis of the optical system based on the user's operation of the zoom ring 115. A position of the zoom lens 112 is always detected by a zoom lens position detector 133b, and is notified to the lens controller 120.

The focus lens 110 is a lens for changing focus of a subject image incident from the optical system and formed on the CMOS image sensor 150. The focus lens 110 may be configured to include any number of the lenses or lens groups.

The focus ring 114 is provided to an outer housing of the interchangeable lens 101. When the user moves the focus ring 114, information on an amount of movement of the focus ring 114 is notified to the lens controller 120. The lens controller 120 instructs the focus lens driver 111 to drive the focus lens 110 based on the notified information on the amount of movement of the focus ring 114. Accordingly, the lens controller 120 recognizes the position of the focus lens 110.

The focus lens driver 111 moves the focus lens 110 along the optical axis of the optical system in forward and backward directions, under the control of the lens controller 120. The focus lens driver 111 can be implemented using, for example, a stepping motor, a DC motor, or an ultrasonic motor.

### 2. Operation

Operations of the digital camera 100 will be described below with reference to the drawings.

### 2-1. Image-Capturing Preparation Operation

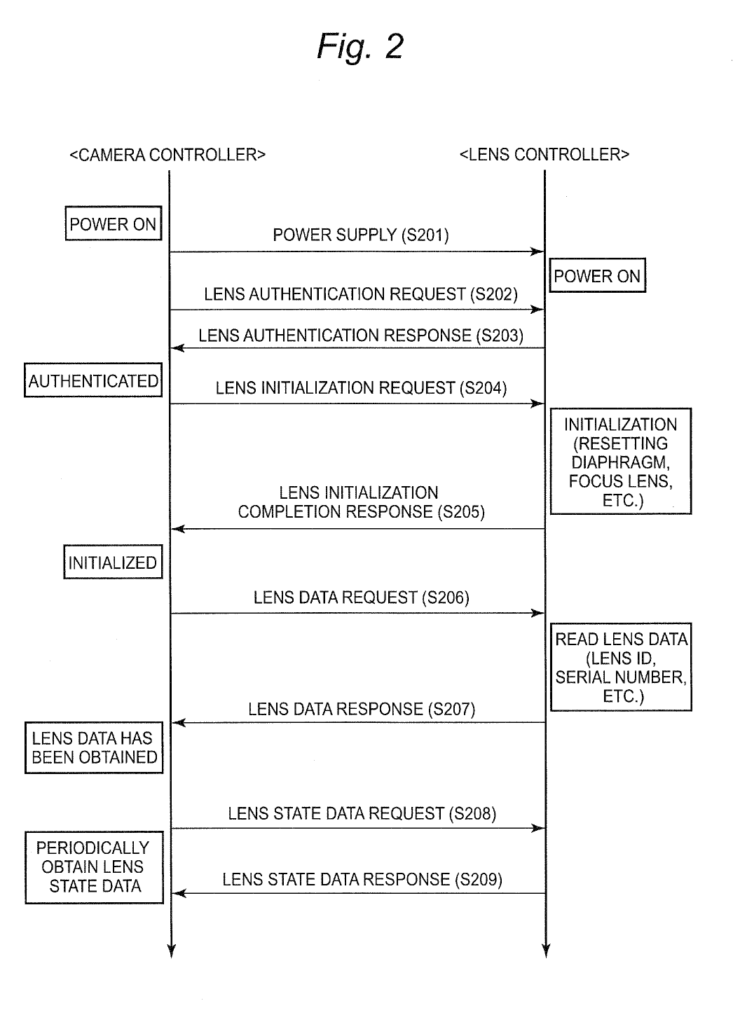

An initialization operation of the digital camera 100 for preparation for capturing an image will be described below. This operation is firstly performed when the digital camera 100 is powered on. FIG. 2 is a diagram describing an operation sequence in the initialization operation of the digital camera 100.

When the interchangeable lens 101 is mounted to the camera body 102 and the user turns the power of the camera body 102 to a power on state using the power switch 152, the power supply 154 supplies power to the interchangeable lens 101 through the body mount 140 and the lens mount 130 (S201). As a result, the interchangeable lens 101 is powered on. The camera controller 153 requests the lens controller 120 to send authentication information on the interchangeable lens 101 (S202). The authentication information on the interchangeable lens 101 includes information on whether or not the interchangeable lens 101 is mounted, and information on whether or not an accessory is attached. The lens controller 120 responds to the request for lens authentication from the camera controller 153 (S203). Thus, the camera controller 153 has authenticated the lens, and can check whether or not the interchangeable lens 101 is mounted to the camera body 102, and whether or not an accessory such as a tele-converter lens or a wide-converter lens is attached.

The camera controller 153 requests the lens controller 120 to perform an initialization operation (S204). In response, the lens controller 120 performs the initialization operation, including resetting a diaphragm (not shown), resetting the focus lens 110, etc. Upon completion of the initialization, the lens controller 120 sends a lens initialization completion response (S205) to the camera controller 153. As a result, the camera controller 153 can determine that the lens has initialized. When the focus lens 110 is reset, the focus lens 110 is moved to a predetermined initial position.

Next, the camera controller 153 requests the lens controller 120 to send lens data (S206). The lens data is stored in the flash memory 122. The lens controller 120 reads the lens data from the flash memory 122, and sends it to the camera controller 153 (S207). The lens data includes information on characteristic values specific to the interchangeable lens 101, such as, for example, a lens name, a lens ID, a serial number, an F number, a focal distance, availability of the motorized zoom function, and resolution characteristic information. The camera controller 153 stores the obtained lens data into the flash memory 156.

Once the camera controller 153 has obtained the lens data about the interchangeable lens 101 mounted to the camera body 102, the digital camera 100 can capture an image. In this state, the camera controller 153 periodically requests the lens controller 120 to send lens state data indicating the state of the interchangeable lens 101 (S208). The lens state data includes information on the magnification of the zoom lens 112, the position of the zoom lens 112, the position of the focus lens 110, the F number, etc. In response to this request, the lens controller 120 sends the requested lens state data to the camera controller 153 (S209).

The camera controller 153 stores the lens state data received from the lens controller 120 (the information on the position of the focus lens 110, the position of the zoom lens 112, etc.) into the DRAM 155.

### 2-2. Setting of Focus Lens Position When Digital Camera Is Powered On

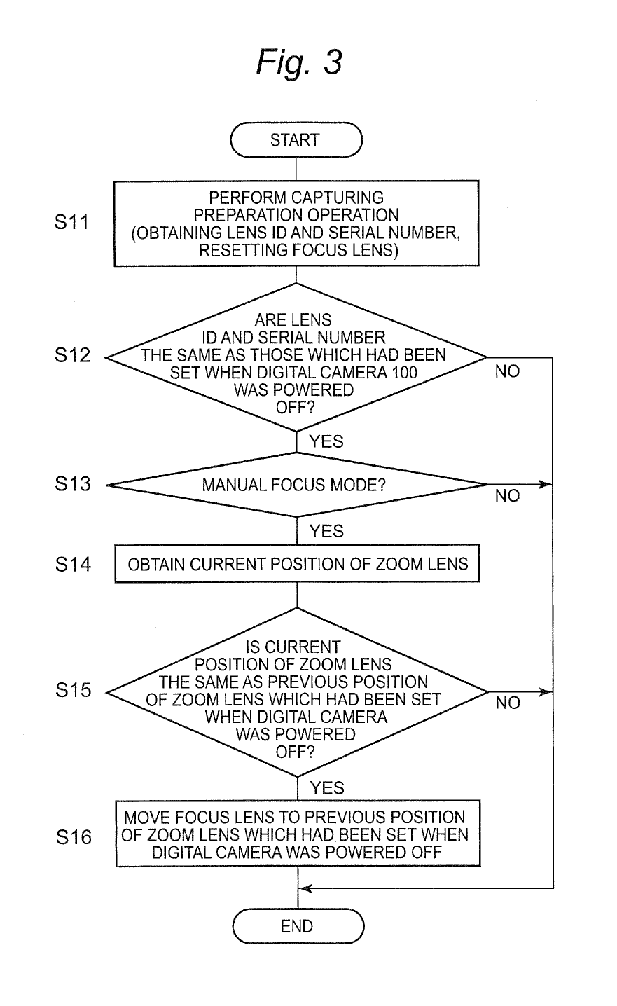

An operation for setting the positions of lenses when the digital camera 100 is powered on will be described with reference to FIG. 3. FIG. 3 is a flowchart of the operation for setting the positions of lenses when the digital camera according to this embodiment is powered on.

When the digital camera 100 is powered on, at first, the capturing preparation operation described above (see FIG. 2) is performed (S11). According to the capturing preparation operation, the camera body 102 obtains the lens ID and the serial number of the interchangeable lens 101, and the focus lens 110 is reset to the initial position.

After the capturing preparation operation has completed, the camera controller 153 compares the lens ID and the serial number of the lens data obtained through the capturing preparation operation, with the lens ID and the serial number stored in the flash memory 156 (S12). That is, the camera controller 153 determines whether or not the interchangeable lens 101 mounted to the camera body 102 when the digital camera 100 is powered on is identical to the interchangeable lens mounted when the digital camera 100 was powered off. When at least one of the lens ID and the serial number obtained through the capturing preparation operation is different from the lens ID and the serial number stored in the flash memory 156, the camera controller 153 judges that different interchangeable lenses are mounted between when the digital camera 100 was powered off and when the digital camera 100 is powered on, and accordingly, the camera controller 153 ends this process. In this embodiment, when the digital camera 100 is powered off, the camera controller 153 stores, into the flash memory 156, the information on the positions of the focus lens 110 and the zoom lens 112 stored in the DRAM 155, before actually turning the power of the digital camera 100 off.

When both the lens ID and the serial number obtained through the capturing preparation operation are equal to the lens ID and the serial number stored in the flash memory 156, the camera controller 153 determines whether or not a focus mode is a manual focus mode (S13). When the focus mode is not the manual focus mode, namely, is an autofocus mode, the camera controller 153 ends this process. This is because in the case of the autofocus mode, the user will not care for displacement of the focus lens.

When the focus mode is the manual focus mode, the camera controller 153 obtains information on a current position of the zoom lens 112 (S14). The current position of the zoom lens 112 can be obtained from the lens state data periodically received from the interchangeable lens 101.

Then, the camera controller 153 determines whether or not the current position of the zoom lens 112 is the same as a previous position of the zoom lens 112 which has been set when the digital camera 100 was powered off (S15). That is, the camera controller 153 determines whether or not the position of the zoom lens 112 has been changed from the previous position of the zoom lens 112 which has been set when the digital camera 100 was powered off. More specifically, the camera controller 153 compares the current position of the zoom lens 112 obtained through the capturing preparation operation, with the position of the zoom lens 112 stored in the flash memory 156.

When the current position of the zoom lens 112 obtained through the capturing preparation operation is the same as the position of the zoom lens 112 stored in the flash memory 156 (i.e., the position which had been set when the digital camera 100 was powered off) (YES at S15), the focus lens 110 is moved from the initial position to the previous position of the focus lens 110 which has been set when the digital camera 100 was powered off (S16). As a result, the focus lens 110 is set to the previous position which had been set when the digital camera 100 was powered off. When the current position of the zoom lens 112 is the same as the position of the zoom lens 112 stored in the flash memory 156 (i.e., the position which had been set when the digital camera 100 was powered off), it is considered that the user has not operated the zoom lens 112 of the digital camera 100 since the digital camera 100 was powered off, and intends to maintain an optical state which had been set when the digital camera 100 was powered off. Therefore, the user's intended lens state can be restored by moving the focus lens 110 from the initial position to the previous position which had been set when the digital camera 100 was powered off.

On the other hand, when the current position of the zoom lens 112 obtained through the capturing preparation operation is not the same as the position of the zoom lens 112 stored in the flash memory 156 (NO at S15), the camera controller ends this process. In this case, the focus lens 110 is kept to be set to the initial position.

According to this embodiment, when the digital camera 100 is powered on, the camera controller 153 determines whether or not the position of the zoom lens 112 has been changed from the previous position which had been set when the digital camera 100 was powered off. When not changed, the position of the focus lens 110 is automatically set to the previous position of the focus lens 110 which had been set when the digital camera 100 was powered off. If the position of the zoom lens has not been changed, it is considered that the user desires the previous focus state and zoom state which had been set when the digital camera 100 was powered off. Therefore, the user's desired optical state can be set according to the control of this embodiment, and the user needs not to set the focus state again, thus improving usability.

### 3. Conclusion

The digital camera 100 according to this embodiment is the digital camera for capturing a subject image to output image data. The digital camera 100 is provided with: the zoom lens 112 configured to move along the optical axis to change magnification of the subject image; the focus lens 110 configured to move along the optical axis to change focus of the subject image, and having the initial position; the focus lens driver 111 configured to move the focus lens 110 along the optical axis; the zoom lens position detector 133b configured to detect the position of the zoom lens 112; the lens controller 120 configured to detect the position of the focus lens 110; the flash memory 156 configured to store the positions of the zoom lens 1112 and the focus lens 110; and the camera controller 153 configured to control operations of the digital camera 100.

The camera controller 153 is configured to: store a first position (previous position) of the zoom lens 112 and a first position (previous position) of the focus lens 110, each position detected when the digital camera 100 is powered off, into the flash memory 156; compare a second position (current position) of the zoom lens 112 detected when the digital camera 100 is powered on, with the first position of the zoom lens 112; and when the second position of the zoom lens 112 is the same as the first position of the zoom lens 112, control the focus lens driver 111 not to move the focus lens 110 to the initial position.

The camera body 102 according to the this embodiment is the camera body to which the interchangeable lens 101 including the zoom lens 112 and the focus lens 110 can be mounted. The focus lens 110 has the initial position. The camera body 102 is provided with: the body mount 140 configured to receive information on the position of the zoom lens 112 and the position of the focus lens 110 from the interchangeable lens 101; the flash memory 156 configured to store the received information on the positions of the zoom lens 112 and the focus lens 110; and the camera controller 153 configured to control operations of the camera body 102. The camera controller 153 is configured to obtain the information on a first position (previous position) of the zoom lens 112 and a first position (previous position) of the focus lens 110 through the body mount 140 when the camera body 102 is powered off, and stores the information on the first position of the zoom lens 112 and the first position of the focus lens 110 into the flash memory 156. Further, the camera controller 153 is configured to obtain the information on a second position (current position) of the zoom lens 112 and a second position (current position) of the focus lens 110 through the body mount 140 when the camera body 102 is powered on, compare the second position of the zoom lens 112 with the first position of the zoom lens 112, and when the second position of the zoom lens 112 is the same as the first position of the zoom lens 112, send a control signal to the interchangeable lens 101 through the body mount 140 for controlling the interchangeable lens 101 not to move the focus lens 110 to the initial position.

According to the above configuration, when it is supposed that the user intends to maintain the lens state which had been set when the digital camera 100 was powered off, it is possible to automatically restore that lens state. Accordingly, the user needs not to set the focus state again, thus improving usability.

### Other Embodiments

The present disclosure is not limited to the above embodiment, and there is other possible embodiments. Some of other exemplary and non-exhaustive embodiments will be described below.

According to the above embodiment, when the current position of the zoom lens 112 which is being set when the digital camera 100 is powered on is the same as the previous position of the zoom lens 112 which had been set when the digital camera 100 was powered off, the focus lens 110 is moved to the previous position of the focus lens 110 which had been set when the digital camera 100 was powered off (step S16 in FIG. 3). However, when the current position of the zoom lens 112 which is being set when the digital camera 100 is powered on is the same as the previous position of the zoom lens 112 which had been set when the digital camera 100 was powered off, the control of the focus lens 110 is not limited to that of the above embodiment. When the current position of the zoom lens 112 which is being set when the digital camera 100 is powered on is the same as the previous position of the zoom lens 112 which had been set when the digital camera 100 was powered off, the focus lens 110 may be controlled so as not to be moved at all. For example, when the digital camera 100 is designed not to set the focus lens 110 to the initial position when the digital camera 100 is powered on, it is considered that the focus lens 110 keeps the previous position which had been set when the digital camera 100 was powered off. In such a case, when the current position of the zoom lens 112 which is being set when the digital camera 100 is powered on is the same as the previous position of the zoom lens 112 which had been set when the digital camera 100 was powered off, it is not necessary to move the focus lens 110.

The above embodiment discloses an exemplary camera system including of the interchangeable lens 101 and the camera body 102. However, the configuration of the imaging apparatus is not limited to such a configuration. That is, the present disclosure can be applied also to a digital camera where lenses are integrated to a camera body. In this case, a controller of the integrated digital camera needs not to execute steps S11 and S12 in the flowchart of FIG. 3 relating to the interchangeable lens.

According to the above embodiment, the digital camera 100 is manually powered off by the user's operation of the power switch 152. However, the power-off is not limited to one based on the user's operation. For example, the control of the above embodiment can be applied to a case where a digital camera has a sleep mode function or an automatic power-off function (i.e., a function for automatically turning power of the digital camera off when the user does not perform any operation for a predetermined time, from a viewpoint of power saving). Further, the power-on operation is not limited to one based on the user's operation of the power switch 152, and may include a case where, after the digital camera was automatically powered off, the digital camera is automatically powered on when the user performs a predetermined operation (operations of a release button or a play button).

The present disclosure can be applied to any imaging apparatus including a zoom lens and a focus lens, such as a digital camera, a movie camera, or a mobile telephone with a camera.

What is claimed is:

1. An imaging apparatus for capturing a subject image to output image data, the apparatus comprising:
a zoom lens configured to move along an optical axis to change a magnification of the subject image;
a focus lens configured to move along the optical axis to change a focus of the subject image, and having a predetermined initial position;
a focus driver configured to move the focus lens along the optical axis;
a zoom position detector configured to detect a position of the zoom lens;
a focus position detector configured to detect a position of the focus lens;
a storing unit configured to store the positions of the zoom lens and the focus lens detected by the zoom position detector and the focus position detector, respectively; and
a controller configured to control an operation of the imaging apparatus,
wherein:
when the imaging apparatus is powered off, the controller stores, in the storing unit, a position of the zoom lens detected at the power-off by the zoom position detector and a position of the focus lens detected at the power-off by the focus position detector, and
when the imaging apparatus is powered on, the controller compares a current position of the zoom lens detected by the zoom position detector with the stored position of the zoom lens, and controls the focus driver not to move the focus lens to the predetermined initial position when the current position of the zoom lens is the same as the stored position of the zoom lens.

2. The imaging apparatus according to claim 1, wherein when the current position of the zoom lens is the same as the stored position of the zoom lens, the controller controls the focus driver to move the focus lens to the stored position of the focus lens.

3. The imaging apparatus according to claim 1, wherein when the current position of the zoom lens is the same as the stored position of the zoom lens, the controller maintains the focus lens at the current position of the focus lens.

4. The imaging apparatus according to claim 1, wherein when the current position of the zoom lens is not the same as the stored position of the zoom lens, the controller controls the focus driver to move the focus lens to the predetermined initial position.

5. A camera body to which an interchangeable lens including a zoom lens and a focus lens is mountable, the camera body comprising:
a communicating unit configured to receive information on a position of the zoom lens and a position of the focus lens from the interchangeable lens;
a storing unit configured to store the information on the positions of the zoom lens and the focus lens received from the communicating unit; and
a controller configured to control an operation of the camera body,
wherein:
when the camera body is powered off, the controller stores, in the storing unit, a position of the zoom lens at the power-off and a position of the focus lens at the power-off,
when the camera body is powered on, the controller:
obtains information on a current position of the zoom lens and a current position of the focus lens through the communicating unit,
compares the obtained current position of the zoom lens with the stored position of the zoom lens, and
when the obtained current position of the zoom lens is the same as the stored position of the zoom lens, a control signal is sent to the interchangeable lens through the communicating unit for controlling the interchangeable lens not to move the focus lens to a predetermined initial position of the focus lens.

6. An imaging apparatus for capturing a subject image to output image data, the apparatus comprising:
a zoom lens configured to move along an optical axis to change a magnification of the subject image;
a focus lens configured to move along the optical axis to change a focus of the subject image, and having a predetermined initial position;
a focus driver configured to move the focus lens along the optical axis;
a zoom position detector configured to detect a position of the zoom lens;
a focus position detector configured to detect a position of the focus lens;
a storing unit configured to store the positions of the zoom lens and the focus lens detected by the zoom position detector and the focus position detector, respectively; and
a controller configured to control an operation of the imaging apparatus as follows:
during a power off operation of the imaging apparatus, a position of the zoom lens detected by the zoom position detector and a position of the focus lens detected by the focus position detector are stored in the storing unit;
during a power on operation of the imaging apparatus, a current position of the zoom lens detected the zoom position detector is compared with the stored position of the zoom lens stored in the storing unit; and
when the current position of the zoom lens is the same as the stored position of the zoom lens, the focus lens is not moved to the predetermined initial position; and
when the current position of the zoom lens is not the same as the stored position of the zoom lens, the focus lens is moved to the predetermined initial position.

7. The imaging apparatus according to claim 6, wherein when the current position of the zoom lens is the same as the stored position of the zoom lens, the controller controls the focus driver to move the focus lens to the stored position of the focus lens.

8. The imaging apparatus according to claim 6, wherein when the current position of the zoom lens is the same as the stored position of the zoom lens, the controller maintains the focus lens at the current position of the focus lens.
